(19) United States
(12) Patent Application Publication
(10) Pub. No.: US 2013/0214747 A1
(43) Pub. Date: Aug. 22, 2013

(54) VOLTAGE CONVERTING APPARATUS

(71) Applicant: Masashi KOBAYASHI, Toyota-shi (JP)

(72) Inventor: Masashi KOBAYASHI, Toyota-shi (JP)

(21) Appl. No.: 13/770,524

(22) Filed: Feb. 19, 2013

(30) Foreign Application Priority Data
Feb. 20, 2012 (JP) 2012-034276

(51) Int. Cl. G05F 3/08

(52) U.S. Cl. CPC G05F 3/08
USPC 323/233

(57) ABSTRACT

A voltage converting apparatus is provided with: a reactor; a first switching element and a second switching element each of which is connected to the reactor in series; a first shunt resistor for detecting a first electric current flowing through the first switching element; a second shunt resistor for detecting a second electric current flowing through the second switching element; a current combining device for combining a detected value of the first electric current and a detected value of the second electric current to generate a combined current; and a detecting device for detecting a current value of the combined current in a plurality of different timings, thereby detecting a peak value and an average value of an electric current flowing through the reactor.

### BACKGROUND OF THE INVENTION

1. Field of the Invention

The present invention relates, for example, to a voltage converting apparatus mounted on a vehicle or the like.

2. Description of the Related Art

Recently, as an environmentally-friendly vehicle, attention has been drawn to an electrically-driven vehicle which is equipped with an electrical storage device (such as for example, a secondary battery and a capacitor) and which drives using a driving force generated from electric power stored in the electrical storage device. The electrically-driven vehicle includes, for example, an electric vehicle, a hybrid vehicle, a fuel-cell vehicle, or the like.

The electrically-driven vehicle is provided, in some cases, with a motor generator which generates the driving force for driving in response to the electric power from the electrical storage device upon departure and acceleration, and which generates electricity due to regenerative braking upon braking and stores electrical energy in the electrical storage device. As described above, the electrically-driven vehicle is equipped with an inverter in order to control the motor generator in accordance with a travelling state.

The vehicle as described above is provided, in some cases, with a voltage converting apparatus (a converter) between the electrical storage device and the inverter in order to stably supply electric power which is used by the inverter and which varies depending on a vehicle state. The converter sets an input voltage of the inverter, which is higher than an output voltage of the electrical storage device, thereby allowing high output of a motor. The converter also reduces a motor current in the same output, thereby allowing a compact, low-cost inverter and motor.

The converter is provided, for example, with two switching elements connected to a reactor, and on-off control of the two switching elements enables voltage conversion. The switching element is provided, in some cases, with, for example, a built-in sensing mechanism for detecting an over-current. As a technology using the sensing mechanism built in the switching element, for example, there has been suggested a technology of detecting a state of the reactor on the basis of whether or not the over-current is detected in the switching element (refer to Japanese Patent Application Laid Open No. 2009-183081).

In order to appropriately control the converter, it is required to detect a current value of a current flowing through the reactor. The technology described in the Patent document 1, however, detects a reduction in inductance of the reactor, and there is no description about the detection of the current value in the reactor. Moreover, even if a reactor current is estimated from the current value detected in the switching element, it cannot be said that it is easy to accurately estimate the current value of the reactor because the sensing mechanism built in the switching element has relatively low accuracy.

Incidentally, there is also a possible method of providing the reactor with a non-contact current sensor; however, the non-contact current sensor cannot detect the over-current as in the sensing mechanism built in the switching element. Thus, the non-contact current sensor and the sensing mechanism built in the switching element cannot integrate functions thereof, resulting in a complicated apparatus configuration.

As described above, the technology described in the Patent document 1 has such a technical problem that the current value of the reactor cannot be preferably detected.

### SUMMARY OF THE INVENTION

It is therefore an object of the present invention to provide a voltage converting apparatus capable of accurately detecting the current value of the reactor in a relatively simple configuration.

The above object of the present invention can be achieved by a voltage converting apparatus provided with: a reactor; a first switching element and a second switching element each of which is connected to said reactor in series; a first shunt resistor for detecting a first electric current flowing through said first switching element; a second shunt resistor for detecting a second electric current flowing through said second switching element; a current combining device for combining a detected value of the first electric current and a detected value of the second electric current to generate a combined current; and a detecting device for detecting a current value of the combined current in a plurality of different timings, thereby detecting a peak value and an average value of an electric current flowing through said reactor.

The voltage converting apparatus of the present invention is, for example, a converter mounted on a vehicle, and is provided with the first switching element and the second switching element each of which is connected to the reactor in series. As the first switching element and the second switching element, for example, an insulated gate bipolar transistor (IGBT), a power supply metal oxide semiconductor (MOS) transistor, a power supply bipolar transistor, or the like can be used.

Incidentally, to each of the first switching element and the second switching element, for example, a diode is connected in parallel to form respective one of a first arm and a second arm. In other words, the first switching element forms the first arm, and a switching operation thereof allows on and off of drive in the first arm to be changed. In the same manner, the second switching element forms the second arm, and a switching operation thereof allows on and off of drive in the second arm to be changed.

In operation of the voltage converting apparatus of the present invention, a switching control signal for changing the on and off of each of the first switching element and the second switching element is generated. Specifically, for example, a duty command signal corresponding to a duty ratio of the first switching element and the second switching element and a carrier signal corresponding to switching frequency of the first switching element and the second switching element are compared with each other, by which the switching control signal is generated. The generated switching control signal is supplied to the first switching element and the second switching element. By this, the drive of the first arm and the second arm in the voltage converting apparatus is controlled.

Moreover, the voltage converting apparatus of the present invention is provided with the first shunt resistor for detecting the first electric current flowing through the first switching element, and the second shunt resistor for detecting the second electric current flowing through the second switching element. The first shunt resistor and the second shunt resistor are provided to be connected in series with the respective switching elements.

The current value of the first electric current detected on the first shunt resistor and the current value of the second electric current detected on the second shunt resistor are combined by the current combining device, which is configured as one portion of a processing unit, such as an electronic controlled unit (ECU), to generate the combined current. Thus, the combined current is obtained by combining the electric current on the first arm side on which the first switching element is disposed and the electric current on the second arm side on which the second switching element is disposed. In other words, it can be said that the combined current is an electric current extremely close to the electric current flowing through the reactor which is connected in series with each of the first switching element and the second switching element.

Here, particularly in the present invention, by the detecting device, which is configured as one portion of the processing unit, such as, for example the ECU described above, the current value of the combined current is detected (or sampled) in the plurality of different timings. This enables detection (accurately, estimation) of the peak value and the average value of the electric current (hereinafter referred to as a “reactor current”, as occasion demands) which flows through the reactor and periodically goes up and down depending on the on and off of the switching elements. Incidentally, the “peak value” herein means a value immediately before each switching element is switched on (i.e. minimum value) and a value immediately before each switching element is switched off (i.e. maximum value). Moreover, the “average value” herein does not mean an average value in a relatively long period, but means an instantaneous average value of the current value which periodically goes up and down depending on the on and off of the switching elements (i.e. a substantial value in a relatively short period of the current value which periodically goes up and down).

The detected peak value is used, for example, to detect an over-current due to an arm short circuit (i.e. for apparatus protection). On the other hand, the detected average value is used, for example, to perform processing for controlling the operation of the voltage converting apparatus (for apparatus control). As described above, in the voltage converting apparatus of the present invention, it is possible to preferably detect the current value used for apparatus protection and the current value used for apparatus control by using the two shunt resistors.

Incidentally, as the method of detecting the reactor current, for example, a method of providing the reactor with a non-contact current sensor is also conceivable; however, the non-contact current sensor has difficulty in detecting the over-current described above. Moreover, for example, a method of providing the switching element with a built-in sensing mechanism is also conceivable; however, the sensing mechanism has relatively low accuracy of detecting the current value, and it is hard to detect the current value for control, which requires high accuracy. As described above, it is not easy to detect the two types of current values used for apparatus protection and for apparatus control by using one type of member.

In the present invention, however, as described above, the two types of current values, which are the peak value and the average value of the reactor current, are detected by using the two shunt resistors. Thus, for example, both the current value for apparatus protection and the current value for apparatus control can be detected by using one type of member. Therefore, a high-performance voltage converting apparatus can be realized in a relatively simple configuration.

In one aspect of the driving assistance apparatus of the present invention, the voltage converting apparatus according to claim 1, wherein said detecting device sets a current value detected in change timing of a switching control signal for changing on and off of said first switching element and said second switching element to be the peak value, and sets a current value detected in timing of a peak and a bottom of a carrier signal for generating the switching control signal to be the average value.

According to this aspect, on the detecting device, the current value detected in the change timing of the switching control signal for changing the on and off of the first switching element and the second switching element is detected as the peak value of the reactor current. Incidentally, the “change timing” herein is timing in which the first switching element and the second switching element are changed from on to off or from off to on, and is, for example, pulse rise timing and pulse fall timing of the switching control signal.

If the current value is detected in the change timing of the switching control signal, the current value immediately before the electric current starts to flow through the first switching element and the second switching element or the current value immediately before the electric current stops is detected. It is thus possible to preferably detect the peak value of the reactor current.

Moreover, in this aspect, on the detecting device, the current value detected in the timing of the peak and the bottom of the carrier signal for generating the switching control signal is detected as the average value of the reactor current.

Herein, in particular, a phase of the carrier signal is shifted by 90 degrees from a phase of the reactor current. Thus, if the current value is detected in the timing of the peak and the bottom of the carrier signal, an intermediate value of the upper and lower peak values of the reactor current is detected. It is thus possible to preferably detect the average value of the reactor current.

The nature, utility, and further features of this invention will be more clearly apparent from the following detailed description with reference to a preferred embodiment of the invention when read in conjunction with the accompanying drawings briefly described below.

### BRIEF DESCRIPTION OF THE DRAWINGS

FIG. 1 is a schematic diagram illustrating an entire configuration of a vehicle equipped with a voltage converting apparatus in an embodiment;

FIG. 2 is a block diagram illustrating a configuration of an ECU;

FIG. 3 is a flowchart illustrating operation of the voltage converting apparatus in the embodiment; and

FIG. 4 is a timing chart illustrating timing of sampling a current value.

### DETAILED DESCRIPTION OF THE PREFERRED EMBODIMENT

Hereinafter, an embodiment of the present invention will be explained with reference to the drawings.

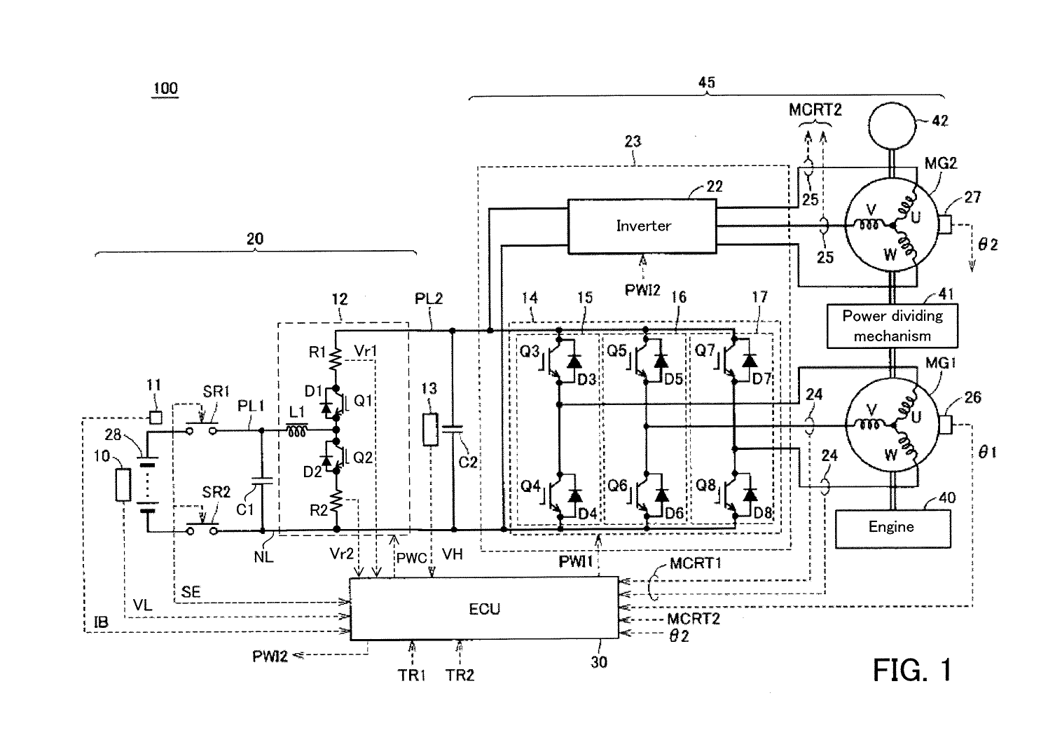

Firstly, an entire configuration of a vehicle equipped with a voltage converting apparatus in the embodiment will be explained with reference to FIG. 1. FIG. 1 is a schematic diagram illustrating the entire configuration of the vehicle equipped with the voltage converting apparatus in the embodiment.

In FIG. 1, a vehicle 100 equipped with the voltage converting apparatus in the embodiment is configured as a hybrid vehicle using an engine 400 and motor generators MG1 and MG2 as a power source. The configuration of the vehicle 100 is not limited to this example, and can be also applied to a vehicle which can drive due to electric power from an electrical storage device (e.g. an electric vehicle and a fuel-cell vehicle). Moreover, in the embodiment, an explanation will be given to the configuration that the voltage converting apparatus is mounted on the vehicle 100; however, the voltage converting apparatus can be applied to any apparatus that is driven by an alternating current (AC) electric motor, other than the vehicle.

The vehicle 100 is provided with a direct current (DC) voltage generation unit 20, a load device 45, a smoothing condenser C2, and an ECU 30.

The DC voltage generation unit 20 includes an electrical storage device 28, system relays SR1 and SR2, a smoothing condenser C1, and a converter 12.

The electrical storage device 28 includes an electrical storage device, such as a secondary battery like, for example, nickel metal hydride or lithium ion, and an electrical double layer capacitor. Moreover, a DC voltage VL outputted by the electrical storage device 28 and a DC current IB inputted and outputted by the electrical storage device 28 are detected by a voltage sensor 10 and a current sensor 11, respectively. The voltage sensor 10 and the current sensor 11 output detected values of the DC voltage VL and the DC current IB, to the ECU 30, respectively.

The system relay SR1 is connected between a positive terminal of the electrical storage device 28 and a power line PL1. The system relay SR2 is connected between a negative terminal of the electrical storage device 28 and a grounding line NL. The system relays SR1 and SR2 are controlled by a signal SE from the ECU 30 to change supply and cutoff of the electric power to the converter 12 from the electrical storage device 28.

The converter 12 is one example of the “voltage converting apparatus” of the present invention. The converter 12 includes a reactor L1, switching elements Q1 and Q2, diodes D1 and D2, and shunt resistors R1 and R2.

The switching elements Q1 and Q2 are one example of the “first switching element” and the “second switching element” of the present invention, respectively, and are connected in series between a power line PL2 and the grounding line NL. The switching elements Q1 and Q2 are controlled by a switching control signal PWC from the ECU 30.

For the switching elements Q1 and Q2, for example, an IGBT, a power supply MOS transistor, a power supply bipolar transistor, or the like can be used. For the switching elements Q1 and Q2, reverse parallel diodes D1 and D2 are provided, respectively. The reactor L1 is disposed between a connection node of the switching elements Q1 and Q2 and the power line PL1. Moreover, the smoothing condenser C2 is connected between the power line PL2 and the grounding line NL.

The shunt resistors R1 and R2 are one example of the “first shunt resistor” and the “second shunt resistor” of the present invention, respectively. The shunt resistors R1 and R2 are provided so as to correspond to the switching elements Q1 and Q2, respectively, as resistive elements for detecting an electric current. In other words, the shunt resistor R1 is configured to detect an electric current Vr1 flowing on the switching element Q1 side. The shunt resistor R2 is configured to detect an electric current Vr2 flowing on the switching element Q2 side. Each of the electric currents Vr1 and Vr2 detected in the shunt resistors R1 and R2 is outputted to the ECU 30.

The load device 45 includes an inverter 23, motor generators MG1 and MG2, an engine 40, a power dividing mechanism 41, and a driving wheel 42. The inverter 23 includes an inverter 14 for driving the motor generator MG1 and an inverter 22 for driving the motor generator MG2. Incidentally, it is not essential to provide two sets of the inverter and the motor generator as illustrated in FIG. 1. For example, either a set of the inverter 14 and the motor generator MG1 or a set of the inverter 22 and the motor generator MG2 may be provided.

The motor generators MG1 and MG2 generate a rotational driving force for propelling the vehicle in response to AC power supplied from the inverter 23. The motor generators MG1 and MG2 receive a rotational force from the exterior, generate AC power due to a regenerative torque command from the ECU 30, and generate a regenerative braking force in the vehicle 100.

The motor generators MG1 and MG2 are also connected to the engine 40 via the power dividing mechanism 41. A driving force generated by the engine 400 and the driving force generated by the motor generators MG1 and MG2 are controlled to have an optimal ratio. Moreover, one of the motor generators MG1 and MG2 may be set to function only as an electric motor, and the other motor generator may be set to function only as a generator. Incidentally, in the embodiment, the motor generator MG1 is set to function as a generator driven by the engine 40, and the motor generator MG2 is set to function as an electric motor driven by the driving wheel 42.

The power dividing mechanism 41 uses, for example, a planetary gear mechanism (planetary gear) is used to divide the power of the engine 40 into the driving wheel 42 and the motor generator MG1.

The inverter 14 drives the motor generator MG1, for example, to start the engine 40 in response to an increased voltage from the converter 12. The inverter 14 also outputs, to the converter 12, regenerative electric power generated by the motor generator MG1 due to the mechanical power transmitted from the engine 40. At this time, the converter 12 is controlled by the ECU 30 to operate as a voltage lowering circuit or a voltage down converter.

The inverter 14 is provided in parallel between the power line PL2 and the grounding line NL, and includes a U-phase upper-lower arm 15, a V-phase upper-lower arm 16, and a W-phase upper-lower arm 17. Each phase upper-lower arm is provided with switching elements which are connected in series between the power line PL2 and the grounding line NL. For example, the U-phase upper-lower arm 15 is provided with switching elements Q3 and Q4. The V-phase upper-lower arm 16 is provided with switching elements Q5 and Q6. The W-phase upper-lower arm 17 is provided with switching elements Q7 and Q8.

Moreover, to the switching elements Q3 to Q8, reverse parallel diodes D3 to D8 are connected, respectively. The switching elements Q3 to Q8 are controlled by a switching control signal PW1 from the ECU 30.

For example, the motor generator MG1 is a three-phase permanent magnet synchronous motor, and one ends of three coils in the U, V, and W phases are commonly connected to a neutral point of the motor generator MG1. Moreover, the other ends of the respective phase coils are connected to connection nodes of the respective phase upper-lower arms 15 to 17, respectively.

The inverter 22 is connected in parallel with the inverter 14 with respect to the converter 12.

The inverter 22 converts a DC voltage outputted by the converter 12 to a three-phase AC voltage and outputs it to the motor generator MG2 for driving the driving wheel 42. Moreover, the inverter 22 outputs regenerative electric power generated by the motor generator MG2 to the converter 12, in association with regenerative braking. At this time, the converter 12 is controlled by the ECU 30 to function as a voltage lowering circuit or a voltage down converter. An internal configuration of the inverter 22 is not illustrated, but is the same as that of the inverter 14, and a detailed explanation thereof will be omitted.

The converter 12 is controlled basically such that the switching elements Q1 and Q2 are switched on and off, complementarily and alternately, within each switching period. The converter 12 increases the DC voltage VL supplied from the electrical storage device 28, to a DC voltage VH (wherein this DC voltage corresponding to an input voltage to the inverter 14 will be also hereinafter referred to as a “system voltage”) in a boosting or voltage increasing operation. The voltage increasing operation is performed by supplying electromagnetic energy stored in the reactor L1 during an ON period of the switching element Q2, to the power line PL2 via the switching element Q1 and the reverse parallel diode D1.

Moreover, the converter 12 lowers the DC voltage VH to the DC voltage VL in a voltage lowering operation. The voltage lowering operation is performed by supplying electromagnetic energy stored in the reactor L1 during an ON period of the switching element Q1, to the grounding line NL via the switching element Q2 and the reverse parallel diode D2.

A voltage conversion ratio (a ratio of VH and VL) in the voltage increasing operation and the voltage lowering operation is controlled by an ON period ratio (duty ratio) of the switching elements Q1 and Q2 in the switching period. Incidentally, if the switching element Q1 is fixed to be ON and the switching element Q2 is fixed to be OFF, it is also possible to set VH=VL (voltage conversion ratio=1.0).

The smoothing condenser C2 smoothes the DC voltage from the converter 12, and supplies the smoothed DC voltage to the inverter 23. A voltage sensor 13 detects a voltage between both ends of the smoothing condenser C2, i.e. the system voltage VH, and outputs a detected value of the system voltage VH to the ECU 30.

In cases where a torque command of the motor generator MG1 is positive (TR1>0), when the DC voltage is supplied from the smoothing condenser C2, the inverter 14 drives the motor generator MG1 to convert the DC voltage to an AC voltage and to output positive torque by a switching operation of the switching elements Q3 to Q8 responding to a switching control signal PWI1 from the ECU 30. In cases where the torque command of the motor generator MG1 is zero (TR1=0), the inverter 14 drives the motor generator MG1 to convert the DC voltage to the AC voltage and to provide zero torque by the switching operation responding to the switching control signal PWI1. By this, the motor generator MG1 is driven to generate zero or positive torque specified by the torque command TR1.

Moreover, upon regenerative braking of the vehicle 100, the torque command TR1 of the motor generator MG1 is set to be negative (TR1<0). In this case, the inverter 14 converts the AC voltage generated by the motor generator MG1 to a DC voltage by the switching operation responding to the switching control signal PWI1, and supplies the converted DC voltage (system voltage) to the converter 12 via the smoothing condenser C2. Incidentally, the regenerative braking herein includes braking associated with power regeneration when a foot brake operation is performed by a driver who drives an electrically-driven vehicle, and deceleration (or stopping acceleration) of a vehicle during the power regeneration by stepping off an accelerator pedal in travelling even though a foot brake is not operated.

In the same manner, the inverter 22 drives the motor generator MG2 to convert the DC voltage to the AC voltage and to provide predetermined torque by the switching operation responding to a switching control signal PWI2 from the ECU 30 corresponding to a torque command of the motor generator MG2.

Current sensors 24 and 25 detect motor currents MCRT1 and MCRT2 flowing through the motor generators MG1 and MG2, respectively, and output the detected motor currents to the ECU 30. Incidentally, the sum of instantaneous values in the U-phase, the V-phase, and the W-phase is zero, and it is thus sufficient to arrange the current sensors 24 and 25 to detect the motor currents in the two phases, as illustrated in FIG. 1.

Rotational angle sensors (resolvers) 26 and 27 detect a rotational angle θ1 of the motor generator MG1 and a rotational angle θ2 of the motor generator MG2, respectively, and transmit the detected rotational angles θ1 and θ2 to the ECU 30. The ECU 30 can calculate rotational speeds MRN1 and MRN2 and angular velocities ω1 and ω2 (rad/s) of the motor generators MG1 and MG2 on the basis of the rotational angles θ1 and θ2, respectively. Incidentally, the rotational angle sensors 26 and 27 may not be provided by directly operating or calculating the rotational angles θ1 and θ2 from a motor voltage and an electric current on the ECU 30.

The ECU 30 includes a central processing unit (CPU), a storage device, and an input/output buffer, and controls each device of the vehicle 100. Incidentally, control performed by the ECU 30 is not limited to processing using software. Dedicated hardware (electronic circuit) can be also established to perform processing.

As a representative function, the ECU 30 controls the operation of the converter 12 and the inverter 23 such that the motor generators MG1 and MG2 output torque according to the torque commands TR1 and TR2, on the basis of the inputted torque commands TR1 and TR2, the DC voltage VL detected by the voltage sensor 10, the DC current IB detected by the current sensor 11, the system voltage VH detected by the voltage sensor 13, the motor currents MCRT1 and MCRT2 from the current sensors 24 and 25, the rotational angles θ1 and θ2 from the rotational angle sensors 26 and 27, and the like. In other words, the ECU 30 generates the switching control signals PWC, PWI1, and PWI2 to control the converter 12 and the inverter 23 as described above, and outputs each of the switching control signals to respective one of the converter 12 and the inverter 23.

In the voltage increasing operation of the converter 12, the ECU 30 feedback-controls the system voltage VH and generates the switching controls signal PWC to match the system voltage VH with a voltage command.

Moreover, when the vehicle 100 becomes into a regenerative braking mode, the ECU 30 generates the switching control signals PWI1 and PWI2 to convert the AC voltage generated by the motor generators MG1 and MG2 to the DC voltage, and outputs the switching control signals to the inverter 23. By this, the inverter 23 converts the AC voltage generated by the motor generators MG1 and MG2 to the DC voltage and supplies it to the converter 12.

Moreover, when the vehicle 100 becomes into the regenerative braking mode, the ECU 30 generates the switching control signal PWC to lower the DC voltage supplied from the inverter 23 and outputs it to the converter 12. By this, the AC voltage generated by the motor generators MG1 and MG2 is converted to the DC voltage, is lowered, and is supplied to the electrical storage device 28.

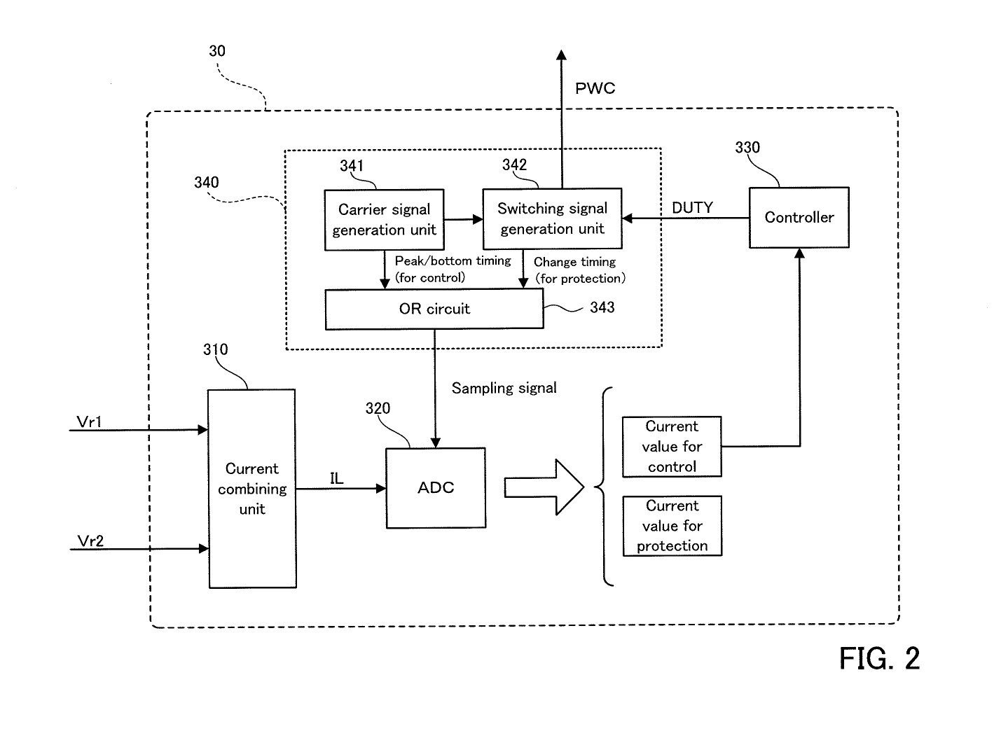

Now, a specific configuration of the ECU described above will be explained with reference to FIG. 2. FIG. 2 is a block diagram illustrating the configuration of the ECU. Incidentally, for convenience of explanation, FIG. 2 illustrates only parts deeply related to the embodiment, out of parts provided for the ECU 30, and the illustration of the other detailed parts is omitted.

In FIG. 2, the ECU 30 is provided with a current combining unit 310, an analog to digital converter (ADC) 320, a controller 330, and a sampling signal generation unit 340. The current combining unit 310 is one example of the “current combining device” of the present invention, and combines the currents Vr1 and Vr2 detected in the shunt resistors R1 and R2 (refer to FIG. 1) to make a combined current. Incidentally, the combined current is equal to an electric current IL flowing through the reactor L1.

The ADC 320 is one example of the “detecting device” of the present invention, and samples and outputs a value of the combined current IL in timing based on a sampling signal generated on the sampling signal generation unit 340. Incidentally, the sampled current value is used as a current value for control and a current value for protection, as detailed later.

The controller 330 generates a duty signal DUTY on the basis of the current value for control, out of the current values detected on the ADC 320. Incidentally, the duty signal DUTY is a signal indicating an ON-OFF period of the switching elements Q1 and Q2.

The sampling signal generation unit 340 includes a carrier signal generation unit 341, a switching signal generation unit 342, and an OR circuit 343.

The carrier signal generation unit 341 generates a carrier signal with a predetermined period to generate the switching control signal PWC. The carrier signal is outputted to the switching signal generation unit 342. Moreover, a signal indicating timing of a peak and a bottom of the carrier signal is outputted to the OR circuit 343.

The switching signal generation unit 342 compares the carrier signal and the duty signal DUTY with each other, thereby generating the switching control signal PWC (in other words, a gate signal) for changing the on and off of the switching elements Q1 and Q2. The generated switching control signal PWC is supplied to each of the switching elements Q1 and Q2. Moreover, a signal indicating change timing of the switching control signal PWC (i.e. timing to change the on and off of the switching elements Q1 and Q2) is supplied to the OR circuit 343.

The OR circuit 343 operates a logical sum of the signal indicating the timing of the peak and the bottom of the carrier signal supplied from the carrier signal generation unit 341 and the information indicating the change timing of the switching control signal PWC supplied from the switching signal generation unit 342, and outputs it to the ADC 320 as the sampling signal.

The ECU 30 explained above is an integral or unified electronic control unit including each of the parts described above, and all the operations of the respective parts are performed by the ECU 30. However, physical, mechanical, and electrical configurations of the parts in the present invention are not limited to this example. For example, each of the parts or devices may be configured as various computer systems, such as microcomputer apparatuses, various controllers, various processing units, and a plurality of ECUs.

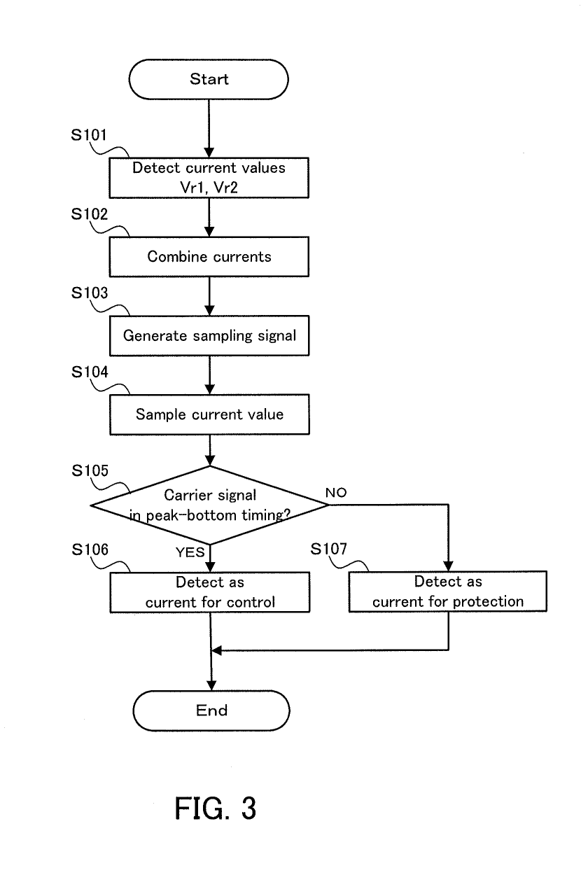

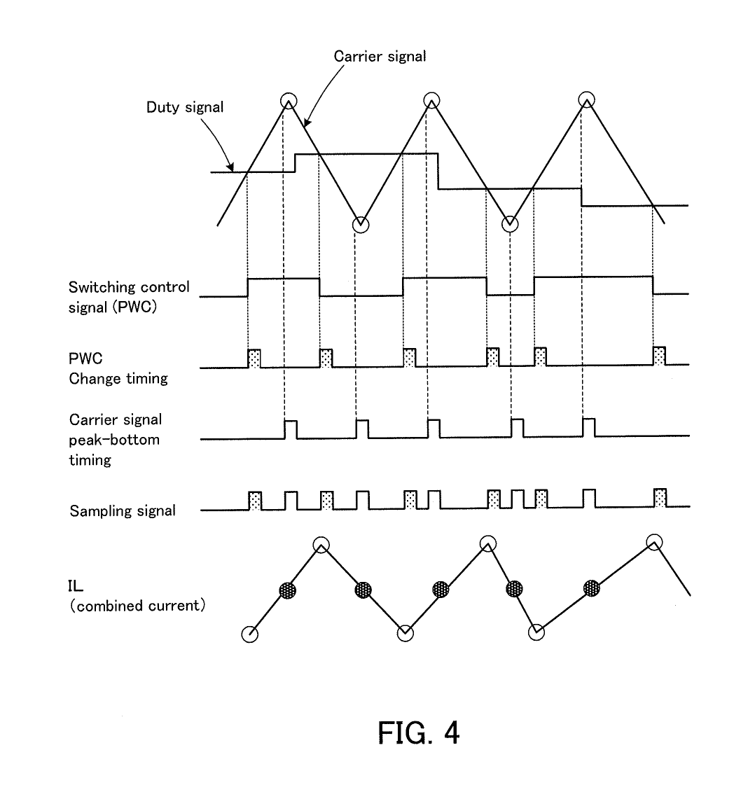

Next, the operation of the converter 12, which is the voltage converting apparatus, will be explained with reference to FIG. 3 and FIG. 4. FIG. 3 is a flowchart illustrating the operation of the voltage converting apparatus in the embodiment. FIG. 4 is a timing chart illustrating timing of sampling the current value. Hereinafter, out of the operation of the converter 12, an operation peculiar to the embodiment will be explained in detail, and the explanation of other general operations will be omitted, as occasion demands.

In FIG. 3, in operation of the converter 12 in the embodiment, firstly, the electric currents Vr1 and Vr2 are detected on the shunt resistors R1 and R2, respectively (step S101). The detected electric currents Vr1 and Vr2 are combined on the current combining unit 310 in the ECU 30, by which the reactor current IL is estimated (step S102).

On the other hand, the sampling signal generation unit 340 generates the carrier signal and the switching control signal PWC, on the basis of which the sampling signal is generated (step S103).

In FIG. 4, it is assumed, for example, that the carrier signal and the duty signal DUTY are signals as illustrated. In this case, the switching control signal PWC is generated such that intersection points of the carrier signal and the duty signal DUTY are the change timing (in other words, pulse rise and fall timing).

If the switching control signal PWC is generated, the logical sum of the signal indicating the change timing of the switching control signal PWC (i.e. the timing corresponding to the intersections of the carrier signal and the duty signal DUTY) and the signal indicating the timing of the peak and the bottom of the carrier signal is operated by the OR circuit 343, by which the sampling signal is generated. The sampling signal is outputted to the ADC 320.

Back in FIG. 3, if the sampling signal is generated, the ADC 320 samples the value of the reactor current IL in the sampling timing indicated by the sampling signal (step S104). Specifically, the ADC 320 samples the reactor current IL in the timing of the peak and the bottom of the carrier signal and in the change timing of the switching control signal PWC.

Here, in particular, if the sampled value is a value sampled in the peak-bottom timing of the carrier signal (step S105: YES), the sampled current value is used as the current value for control (step S106). On the other hand, if the sampled value is a value sampled in the change timing of the switching control signal PWC (step S105: NO), the sampled current value is used as the current value for protection (step S107).

Back in FIG. 3, the current value sampled in the peak-bottom timing of the carrier signal, as can be seen from the drawing, is the average value of the reactor current IL which goes up and down due to the on and off of the switching elements Q1 and Q2. Thus, if the current value sampled in the peak-bottom timing of the carrier signal is used as the current value for control (e.g. a current value for generating the duty signal), the operation of the converter 12 can be preferably controlled.

On the other hand, the current value sampled in the change timing of the switching control signal PWC, as can be seen from the drawing, is the peak value (i.e. the value of the peak or the bottom) of the reactor current IL which goes up and down due to the on and off of the switching elements Q1 and Q2. Thus, if the current value sampled in the change timing of the switching control signal PWC is used as the current value for protection (e.g. a current value for detecting an over-current), the reliability of the converter 12 can be preferably improved.

As explained above, according to the voltage converting apparatus in the embodiment, the use of the shunt resistors R1 and R2 allows the detection of two types of current values, which are the peak value and the average value of the reactor current IL. Thus, as described above, it is possible to preferably detect the current value for protecting and the current value for controlling the converter 12.

In the embodiment described above, an explanation was given to cases where the sampling is performed in the peak-bottom timing of the carrier signal and in the change timing of the switching control signal PWC; however, the sampling may be performed in other timing. The detected current value may be also used for a different purpose from the current value for protection and the current value for control described above.

The invention may be embodied in other specific forms without departing from the spirit or essential characteristics thereof. The present example is therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2012-034276 filed on Feb. 20, 2012 including the specification, claims, drawings and summary is incorporated herein by reference in its entirety.

What is claimed is:

1. A voltage converting apparatus comprising:
a reactor;
a first switching element and a second switching element each of which is connected to said reactor in series;
a first shunt resistor for detecting a first electric current flowing through said first switching element;
a second shunt resistor for detecting a second electric current flowing through said second switching element;
a current combining device for combining a detected value of the first electric current and a detected value of the second electric current to generate a combined current; and
a detecting device for detecting a current value of the combined current in a plurality of different timings, thereby detecting a peak value and an average value of an electric current flowing through said reactor.

2. The voltage converting apparatus according to claim 1, wherein said detecting device sets a current value detected in change timing of a switching control signal for changing on and off of said first switching element and said second switching element to be the peak value, and sets a current value detected in timing of a peak and a bottom of a carrier signal for generating the switching control signal to be the average value.
